(19) United States
(12) Patent Application Publication
(10) Pub. No.: US 2003/0103202 A1
(43) Pub. Date: Jun. 5, 2003

(54) Monolithic multiple fiber holder

(76) Inventor: Paul S. Schmitt, Big Flats, NY (US)

Correspondence Address: CORNING INCORPORATED, SP-TI-3-1, CORNING, NY, 14831

(21) Appl. No.: 10/001,010

(22) Filed: Nov. 30, 2001

(51) Int. Cl. G02B 6/00

(52) U.S. Cl. 356/137

(57) ABSTRACT

A monolithic fiber holder includes one or more V-grooves with a vacuum slot is formed in the apex of the V-groove utilizing electrical discharge machining to communicate with a vacuum feed aperture. Pilot holes are formed transversely through a vacuum feed aperture positioned in spaced relationship to the V-groove and communicate through a lower surface of the block and through the V-groove to allow an electrical discharge machining wire to extend transversely through the aperture in the V-groove to discharge erode a slot along the apex of the V-groove. The pilot hole extending through the vacuum feed hole is then sealed. In another embodiment, a shaped electrode probe is employed in a sinker-type electrical discharge method to erode the apex of a V-groove to form a vacuum slot between the vacuum feed aperture and the V-groove. The holders are preferably made of tungsten carbide.

### BACKGROUND OF THE INVENTION

1. Field of the Invention

The present invention relates to fiber holders which are employed to hold fibers in alignment for testing optical circuits.

2. Technical Background

During the manufacturing of optical circuits, such as planar waveguides that include switches, wave division multiplexers, fiber Bragg gratings or the like, it is necessary subsequent to the manufacture of the devices to test them for quality performance standards. In order to do so, it is necessary to couple input and output signals to such devices through the coupling of input and output optical fibers from signal sources and detectors to input and output ports of the optical components under test. To minimize coupling losses, it is necessary to precisely align and hold the fibers and, in some applications, pairs of fibers with ends in alignment with one another.

In the past, a two-piece holder has been employed in which one half of a V-groove is machined in a base and the remaining half of the V-groove is formed in an insert segment, which is machined to fit within a recess in the base. The lower edges of the apex of the V-groove forming walls are machined to define a shallow groove to communicate with a vacuum feed hole when the two-piece holder is assembled. A vacuum source is coupled to the vacuum feed hole to hold fibers within the V-groove such that input or output fibers can be positioned along the V-groove from one end of the holder and aligned with input/output ports or input/output fibers of a device be tested in precise facing alignment. Such holders may include multiple V-grooves with a distance between them selected to correspond to the pitch between input/output fibers or ports of a device under test.

Although such holders are relatively easy to manufacture, the accumulated tolerances and corresponding fits between the inserts and base sections are extremely difficult to maintain and can vary from holder to holder, leading to inaccuracies in testing results when such multiple piece holders are employed during testing of optical components.

### SUMMARY OF THE INVENTION

There exists a need, therefore, for an improved holder and method of manufacturing a holder for temporarily aligning and holding optical fibers for the testing of optical components which eliminates the imprecise tolerances and variability in fit inherent with multiple piece holders.

The holder of the present invention satisfies this need by providing a monolithic fiber holder in which one or more grooves, such as generally V-shaped grooves, are precisely machined. Vacuum slots are formed in the bottom or apices of V-shaped grooves utilizing electrical discharge machining (EDM) to provide a slot in the groove communicating with a vacuum feed aperture. In a preferred embodiment of the invention, a block of low thermal expansion, stable, isotropic wear-resistance material, such as tool steel or preferably tungsten carbide, is employed for the monolithic holder. One or more grooves are formed in the block, each with an associated vacuum feed hole formed in the block in spaced relationship to the groove. To manufacture such holders in one embodiment, pilot holes are formed transversely through the apex of a generally V-shaped groove and extend through a lower surface of the block to allow an electrical discharge machining wire to extend transversely through the pilot aperture in the groove. Subsequently, a potential is applied between the wire and the block in a circulating dielectric fluid, and the wire is manipulated along the longitudinal length of the bottom of the groove to discharge erode a slot along the groove (which is the apex of a V-shaped groove), which communicates with the associated vacuum feed hole. The pilot hole and eroded area extending through the vacuum feed hole opposite the groove is then sealed. Such technique and resultant structure can be employed for providing a plurality of grooves in a monolithic block of a holder spaced apart at a pitch corresponding to the pitch of input/output fibers of optical components, such as planar waveguides.

In another embodiment of the invention, a monolithic block is provided with one or more grooves, such as generally V-shaped grooves, under which there extends in spaced relationship a vacuum feed hole. A shaped electrode probe is employed in a sinker-type electrical discharge machining method to erode a vacuum communication slot between the vacuum feed hole and the bottom of the groove into which optical fibers can be precisely aligned and held during testing.

Either manufacturing method results in a monolithic (i.e., integral, one-piece) holder having one or more precision grooves formed therein, each with a slot extending through the bottom and communicating with a vacuum feed hole positioned in spaced relationship to the groove.

Additional features and advantages of the invention will be set forth in the detailed description which follows and will be apparent to those skilled in the art from the description or recognized by practicing the invention as described in the description which follows together with the claims and appended drawings.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention which, together with their description serve to explain the principals and operation of the invention.

### BRIEF DESCRIPTION OF THE DRAWINGS

FIG. 1 is an exploded perspective view of a two-piece holder of the prior art;

FIG. 2 is a perspective view of the monolithic holder of the present invention;

FIG. 3 is a perspective, partly broken away view of the monolithic holder of the present invention shown in FIG. 2 illustrating a manufacturing step;

FIG. 4 is a top plan view of the holder shown in FIGS. 2 and 3;

FIG. 5 is a front elevational view of the holder shown in FIG. 4;

FIG. 6 is an enlarged detailed view of the circled area VI-VI of FIG. 4;

FIG. 7 is a cross-sectional view of the holder taken along section lines VIII of FIG. 5;

FIG. 8 is an end elevational view of one of the V-grooves of the holder of the present invention, shown with a stripped fiber placed therein; and

FIG. 9 is a perspective, partly broken away view of the monolithic holder of the present invention shown in FIG. 2 illustrating a different manufacturing step.

### DETAILED DESCRIPTION OF THE PREFERRED EMBODIMENT

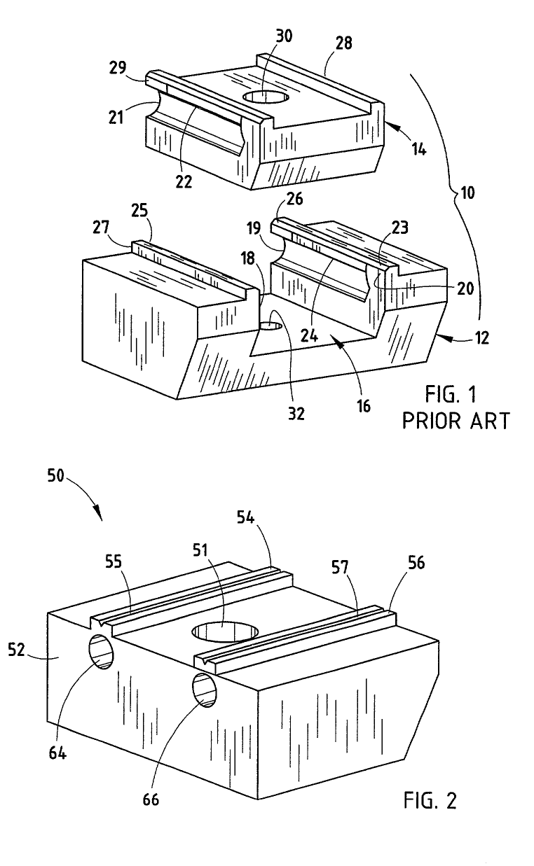

Referring initially to FIG. 1, there is shown a prior art two-piece holder 10, which includes a base 12 and a separate insert 14. Holder 10 includes a pair of V-shaped grooves, formed as described below, spaced to define a pitch for positioning two pairs of optical fibers in alignment with one another between a device under test and testing equipment. The input fiber may include, for example, an optical signal source, while the output fiber may be coupled to a spectrometer for detecting the operation of the optical component under test. Base 12 of the two-piece holder 10 is a block of material, such as machined steel, tungsten carbide, or the like, and is generally rectangular and includes a central, generally U-shaped recess 16 for receiving the generally rectangular insert block 14 therein. Side walls 18 and 20 of base 12 are machined to include semicylindrical vacuum feed apertures 19 (one shown) which cooperate with similar semicylindrical apertures 21 (one shown) of insert 14. One half of the V-shaped grooves are formed in the base 12 in raised surfaces 26 and 27 at 45° angles, while the other side of the V-shaped grooves are formed on edges 28 and 29 of insert 14, such that when insert 14 is placed within recess 16, the 45° sloped faces 26 and 28 define a 90° V-groove along raised surface 23 and the 45° sloped surfaces 25 and 29 define a 90° V-shaped groove on raised surface 27.

In order to provide a communication path from the apices of the V-shaped grooves so formed, a shallow relief 24 is formed at the bottom of surfaces 25 and 26 of base 12 and similarly at the bottom 22 of V-shaped groove-forming surfaces 28 and 29 of insert 14 to define a narrow slot at the apex of the V-shaped grooves which communicates with vacuum apertures 19 and 21. A mounting aperture 30 is formed in insert 14 and communicates with an aligned aperture 32 in base 12 for mounting the insert to the base and the combination to a precision slide for aligning the holder with an optical component under test.

As can be appreciated with such a system, not only is it necessary to precisely machine one half of each V-groove in the holder and the insert, it is further necessary to precisely machine the reliefs 24 and 26 at the bottom of the V-groove and assure the side walls 18 and 20 of the base are precisely dimensioned to receive the side walls of insert 14. Although the base and insert themselves are relatively easy to machine, the tolerances required to provide precise alignment of the resultant V-grooves formed is very difficult and results in coupling mismatches of optical fibers positioned in V-grooves for coupling signals between them and devices under test. As a result, there is a need for a more precise optical fiber holder which improves coupling of the optical fibers and which can be made economically. The holder of the present invention, shown in FIGS. 2-9, satisfies this need and is now described.

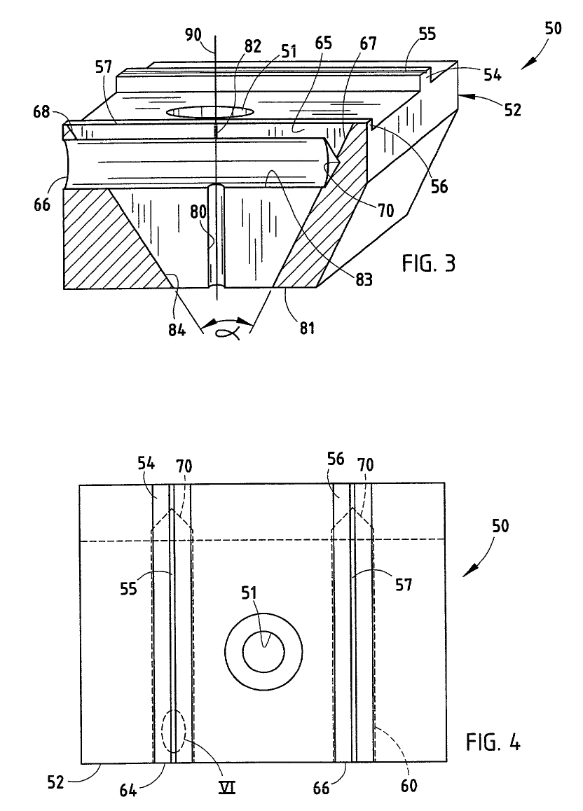

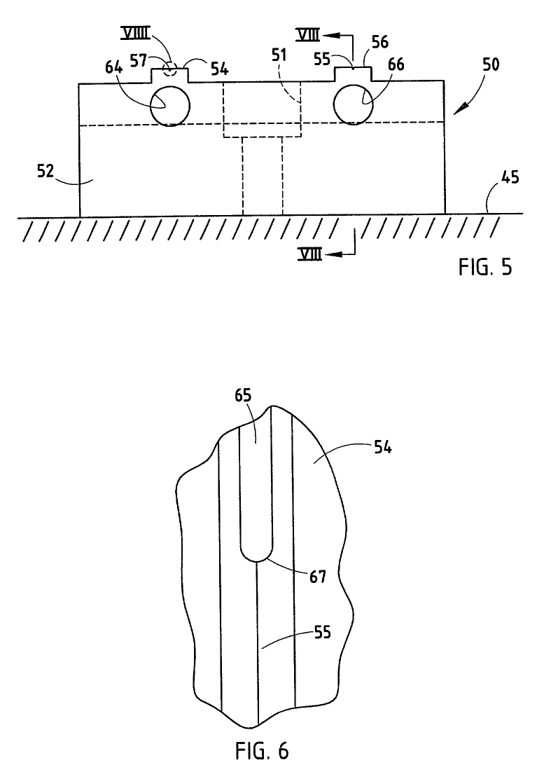

In FIG. 2, a monolithic dual fiber holder 50 is shown, although as can be appreciated, any number of V-shaped grooves for holding multiple pairs of fibers can be incorporated in the monolithic holder 50 of the present invention. Holder 50 comprises a single, one-piece (i.e., monolithic) block 52 of a material which has a low thermal expansion, is stable, isotropic in structure, and wear resistant. The preferred material is tungsten carbide, although tool steel could also be employed. The block 52 includes a pair of raised surfaces 54 and 56 in which there is precisely machined grooves, such as 900 V-shaped grooves, 55 and 57 which extend longitudinally substantially along the length of the raised surfaces 54 and 56. Although V-shaped grooves are employed in the preferred embodiment, other shape grooves, such as U-shaped grooves or a hybrid between them can be employed. In some embodiments, the generally V-shaped grooves have rounded apices or can have a half-hexagon profile. Also, the angle of sides of the grooves can vary from about 90° to about 120°. Below and aligned with the raised surfaces 54 and 56 are vacuum feed apertures 64 and 66 which are coupled to the V-grooves by narrow slots 65 (FIGS. 3, 6, 8 and 9) which extend only partially along the apex of the V-grooves 55 and 57, terminating at blind ends 67 and 68 (FIGS. 3 and 6) to allow a vacuum, such as a half atmosphere applied to the vacuum feed apertures 64 and 66, and through the apices of V-shaped grooves 55 and 57 for holding a stripped fiber, such as fiber 40 (FIG. 8), in the V-shaped grooves 55 and 57. Block 52 also includes a center counter bored stepped aperture 51 (FIGS. 2 and 4) for mounting the holder 50 to a precision slide 45 (FIG. 5) for aligning input and output fibers from test equipment to input/output fibers of an optical fiber component under test. The use of raised surfaces 54 and 56 eliminates the need for precisely machining the entire upper surface of block 52. The grooves, however, could be machined directly into the upper surface of block 52 without the benefit of the raised surfaces.

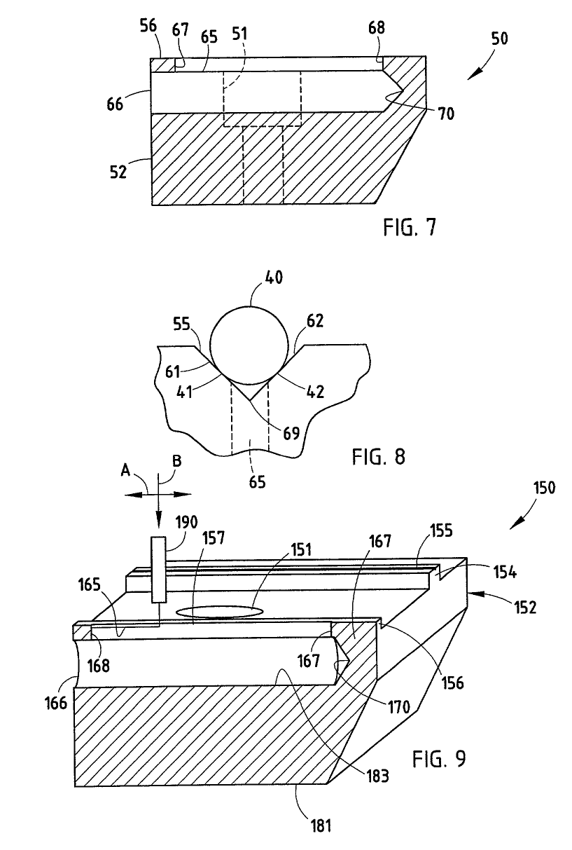

The V-shaped grooves 55 and 57 can be precisely machined in the raised surfaces 54 and 56, which raised surfaces each have a width of approximately 0.040″ and a height of approximately 0.030″. The grooves are centered in the raised surfaces and extend the entire length of the raised surfaces, which in one embodiment was approximately 0.591″. The vacuum slots 65 in each of the raised surfaces were laterally centered on the raised surfaces and spanned approximately 0.541″ between the blind ends 67 and 68 of the overall length of the raised surfaces. V-shaped grooves 55 and 57, as seen in FIG. 8, span an arc of 90° and have a vertical depth of approximately 0.0034″. The apices 69 of the grooves communicate with the slots 65 formed in the block 52, as described below. Slots 65 have a width of approximately 0.003″ such that the tangent points 41 and 42 (FIG. 8) of a fiber 40, having a stripped diameter of about 0.005″ or 125 μm, engage the side walls 61 and 62 of V-shaped grooves 55 and 57 slightly above the intersection of slot 65 to the sides of V-shaped slots 55 and 57 to seal the fiber 40. Thus, when vacuum is applied to vacuum feed apertures 64 and 66 and slots 65 in the bottom of the grooves, the fibers are held in aligned position, as illustrated in FIG. 8. The spacing between raised surfaces 54 and 56 is selected to correspond to the pitch of the optical component under test and typically several holders 50 with two or more V-shaped fiber-holding grooves are manufactured for testing several different devices. The diameter of vacuum feed apertures 64 and 66 is about 0.087″ in one embodiment, and, as seen in FIG. 7, they extend transversely through block 52 terminating in a blind end 70 (FIGS. 4 and 7) to allow vacuum to be drawn through slots 65 in the apices of V-grooves 55 and 57.

The slots 65 in the apices of the precision machined V-grooves 55 and 57 of holder 50 are machined utilizing electrical discharge machining either of the wire-type electrical discharge machining or a probe (sinker) type electrical discharge machining. The wire electrical EDM discharge machining method is illustrated in FIG. 3 and can be accomplished utilizing a commercially available EDM machine, such as a Mitsubishi CNC Wire EDM Model DWC90CR, which is employed as illustrated in FIG. 3.

A lower pilot hole 80 extends from the bottom 81 of block 52 to the inner surface 83 of vacuum feed hole 66. Pilot hole 80 is formed by a diamond drill and typically has a diameter of approximately 0.032″ and is precisely axially aligned with an upper pilot hole 82 extending downwardly through the apex of V-groove 57 of raised surface 56 and having a diameter of approximately 0.004″. These pilot holes are located at the midway point of length of V-shaped grooves 55 and 57. Similar upper and lower pilot holes are formed in V-shaped groove 55 in raised surface 54.

An electrical discharge machining wire 90 having a diameter of approximately 0.0015″ is extended through pilot holes 80 and 82, and block 52 is immersed in a circulating dielectric fluid in a conventional manner. The EDM machine then manipulates wire 90 in an arc α, as shown in FIG. 3, to precisely erode the slot 65 in the apex of each of the V-shaped grooves 55 and 57 and to define blind ends 67 and 68 of slot 65 proximate the ends of grooves 55 and 57 in raised surfaces 54 and 56, respectively. The angle α depends upon the height of the block which, in one embodiment, was about 0.315″, with angle u being approximately 60°. The wire EDM process itself is conventional and provides precise machining of the slot 65 in the bottom of V-grooves 55 and 57 by applying an electrical potential between electrode wire 90 and the metallic block 52, thereby vaporizing and removing the material to define slot 65 while the circulating dielectric fluid removes debris during the process.

Subsequent to the machining of slot 65 in the bottom of the previously formed grooves 55 and 57, the lower pilot hole 80 and the trapezoidal slotted area 84 (FIG. 3)is plugged to seal the vacuum feed apertures 64 and 66 from the bottom, such that when a vacuum is applied to the vacuum feed apertures, it draws only against slots 65. The plugging of pilot hole 80 and trapezoidal eroded area 84 can be achieved by the use of adhesives or hard waxes. While not necessary, the upper pilot hole 82 can also be sealed. Instead of the wire-type EDM method of manufacture as illustrated in FIG. 3, a probe or sinker-type EDM machining process can be used as illustrated in FIG. 9.

In FIG. 9, there is shown a fiber holder 150 (the same reference numerals as the first embodiment are used preceded by a “1”) which, once manufactured, is substantially the same as holder 50. Slots 165 are formed in grooves 155 and 157 of holder 150 using a shaped electrode 190 having a thickness of about 0.001″, which is introduced by a sinker-type EDM machine, such as a Mitsubishi VX-10CNC sinker EDM. This process takes place by immersing block 152 in a circulating dielectric fluid and applying an electrical potential between electrode 190 and block 152 while introducing the shaped electrode or probe 190 to the bottom of each of the V-grooves 155 and 157 from above block 152, translating the probe in the direction of arrow A in FIG. 9 along the grooves and moving it downwardly in the direction of arrow B to the apex of the V-grooves. This forms slots 165 communicating with vacuum feed apertures 164 and 166. In this embodiment, it is unnecessary to form pilot holes inasmuch as the slots are formed from above the V-grooves and no wire is employed.

With either system, a monolithic holder 50, 150 can first be precisely machined using conventional machining equipment to include the raised surfaces 54 and 56 and the V-grooves 55 and 57 formed therein and subsequently the vacuum slots communicating between the vacuum feed holes and the apices of the V-grooves also precisely formed utilizing a wire or sinker EDM equipment. The resultant monolithic fiber holder more precisely aligns the fibers inasmuch as the 90° V-shaped grooves, shown in detail in FIG. 8, can be precisely formed at one time without inter-fitting two separate pieces to define side walls of the V-shaped grooves as in the prior art two-piece holders. The resultant holder more precisely aligns the ends of optical fibers 40 for coupling signals between them when the holder is employed for testing optical components.

It will become apparent to those skilled in the art that various modifications to the preferred embodiment of the invention as described herein can be made without departing from the spirit or scope of the invention as defined by the appended claims.

The invention claimed is:

1. A monolithic holder for comprising:
a one-piece body having at least one groove formed along a surface thereof for holding optical fibers in alignment in the groove;
a vacuum feed aperture formed through the body in spaced relationship to the groove; and
a vacuum slot extending between the apex of the groove and the vacuum feed aperture for holding fibers in position in the groove upon application of a vacuum to the vacuum feed aperture.

2. The monolithic holder as defined in claim 1 wherein the vacuum slot extends only partially along the length of the groove.

3. The monolithic holder as defined in claim 2 wherein the body includes a raised surface and the groove is formed in the raised surface.

4. The monolithic holder as defined in claim 1 wherein the body includes at least two grooves and two vacuum feed apertures each formed in spaced relationship to an associated groove and a vacuum slot extending between each of the vacuum feed apertures and an associated groove.

5. The monolithic holder as defined in claim 1 wherein the vacuum slot is formed by a wire EDM process.

6. The monolithic holder as defined in claim 1 wherein the vacuum slot is formed by a sinker EDM process.

7. The monolithic holder as defined in claim 1 wherein the vacuum slot has a width of about 0.003″ and extends between and spaced inwardly from opposite ends of the groove.

8. The monolithic holder as defined in claim 7 wherein the groove is generally V-shaped.

9. The monolithic holder as defined in claim 8 wherein the groove is formed by side walls converging at an angle of from about 90° to about 120°.

10. A monolithic holder for optical fibers comprising:
an integral one-piece block of thermally stable wear-resistant material having at least one generally V-shaped groove formed along a surface thereof;
a vacuum feed aperture formed through the block in spaced relationship to the V-shaped groove; and
a vacuum slot extending between the bottom of the generally V-shaped groove and the vacuum feed aperture for holding fibers in position in the generally V-shaped groove upon application of a vacuum to the vacuum feed hole.

11. The monolithic holder as defined in claim 10 wherein the vacuum slot extends only partially along the length of the V-shaped groove.

12. The monolithic holder as defined in claim 11 wherein the block includes a raised surface and the V-shaped groove is formed in the raised surface.

13. The monolithic holder as defined in claim 12 wherein the block includes at least two generally V-shaped grooves and two vacuum feed apertures each formed in spaced relationship to an associated generally V-shaped groove and a vacuum slot extending between each of the vacuum feed apertures and an apex of an associated generally V-shaped groove.

14. The monolithic holder as defined in claim 10 wherein the material is an isotropic thermally stable metal.

15. The monolithic holder as defined in claim 14 wherein the material is one of tungsten carbide and tool steel.

16. The monolithic holder as defined in claim 10 wherein the vacuum slot is formed by a wire EDM process.

17. The monolithic holder as defined in claim 10 wherein the vacuum slot is formed by a sinker EDM process.

18. A monolithic holder for optical fibers having a body with at least one groove formed along a surface thereof, a vacuum feed aperture formed through the body in spaced relationship to the groove, and a vacuum slot extending between the groove and vacuum feed aperture for holding a fiber in position in the groove upon application of a vacuum to the vacuum feed hole, wherein the vacuum slot is formed by extending an EDM wire through pilot apertures extending between the bottom of the groove and through the body opposite the vacuum aperture from the groove and manipulating the wire using a wire EDM process to vaporize the body to form the vacuum slot extending partially along the groove, and subsequently sealing the void formed in the body adjacent the vacuum feed aperture.

19. The monolithic holder as defined in claim 18 wherein the body is made of an isotropic thermally stable material.

20. The monolithic holder as defined in claim 19 wherein the body is tungsten carbide.

21. The monolithic holder as defined in claim 20 wherein the groove is V-shaped.

22. A monolithic holder for optical fibers having a one-piece body with at least one groove formed along a surface thereof, a vacuum feed aperture formed through the body in spaced relationship to the groove, and a vacuum slot extending between the groove and the vacuum feed aperture for holding a fiber in position in the groove upon application of a vacuum to the vacuum feed hole wherein the vacuum slot is formed by extending an EDM probe onto the bottom of the groove and manipulating the probe using a sinker EDM process to vaporize the body to form the vacuum slot extending partially along the groove.

23. The monolithic holder as defined in claim 22 wherein the body is an isotropic thermally stable material.

24. The monolithic holder as defined in claim 23 wherein the body is tungsten carbide.

25. The monolithic holder as defined in claim 24 wherein the groove is V-shaped.

26. A method of forming a monolithic optical fiber holder comprising the steps of:
machining at least one generally V-shaped groove in a surface of a monolithic block of metal;
forming a vacuum supply aperture in the block in spaced relationship to the apex of the generally V-shaped groove;
forming a first pilot hole through the bottom of the generally V-shaped groove into the vacuum forming aperture;
forming a second pilot hole in axial alignment with the first pilot hole and extending through the block on the side of the vacuum feed aperture opposite the V-shaped groove;
extending an EDM wire through said first and second pilot holes; and
manipulating said EDM wire while applying a voltage between the wire and the block in a circulating dielectric fluid while manipulating the wire along the apex of the generally V-shaped groove to form a vacuum slot at the apex of the V-shaped groove communicating with the vacuum feed aperture.

27. The method as defined in claim 26 and further including the step of sealing at least the second pilot hole and the surrounding area vaporized by the EDM wire.

28. A method of forming a monolithic optical fiber holder comprising the steps of:
machining at least one generally V-shaped groove in a surface of a monolithic block of metal;
forming a vacuum supply aperture in the block in spaced relationship to the apex of the generally V-shaped groove;
positioning a shaped EDM electrode in alignment with the apex of the V-shaped groove;
applying a potential between the EDM electrode and the block in a circulating dielectric fluid to vaporize the bottom of the V-shaped groove to form a vacuum slot between the V-shaped groove and the vacuum feed aperture.
